(19) United States
(12) Patent Application Publication
(10) Pub. No.: US 2017/0167114 A1
(43) Pub. Date: Jun. 15, 2017

(54) HYDRAULIC CLAM ACTUATOR VALVE BLOCK

(71) Applicant: Caterpillar Global Mining LLC, South Milwaukee, WI (US)

(72) Inventors: Karla Winkel, Bochum (DE); Martin Kunigk, Bochum (DE); Heinz Otto, Bochum (DE)

(73) Assignee: Caterpillar Global Mining LLC, South Milwaukee, WI (US)

(21) Appl. No.: 15/371,743

(22) Filed: Dec. 7, 2016

(30) Foreign Application Priority Data
Dec. 15, 2015 (EP) 15200159.0

(51) Int. Cl. E02F 9/22; E21C 27/30; E02F 3/407; E02F 3/30; F15B 15/20; E02F 3/42

(52) U.S. Cl. CPC E02F 9/2267; F15B 15/202; E02F 3/42; E02F 3/4075; E02F 3/308; E21C 27/30; E02F 9/2271; F15B 2211/25; F15B 2211/7052

(57) ABSTRACT

A hydraulic valve block configured to specifically control an operation of a clam actuator of a face shovel bucket of a face shovel machine is disclosed. The hydraulic valve block comprises a first inlet, a second inlet, a first outlet connected to the first inlet via a first line and a second outlet connected to the second inlet via a second line. The hydraulic valve block further comprises a two port two position directional control valve interconnected between the first line and the second line, a first pressure relief valve interconnected between the first line and the second line and arranged in series with the two port two position directional control valve, and a second pressure relief valve interconnected between the first line and the second line and arranged in parallel to the first pressure relief valve and the two port two position directional control valve.

### TECHNICAL FIELD

The present disclosure generally relates to a hydraulic valve block for controlling a hydraulic actuator and, in particular, to a hydraulic clam actuator valve block for controlling a clam actuator of a face shovel bucket of a face shovel machine.

### BACKGROUND

There a generally two types of mining shovels. Backhoe machines and face shovel machines. Backhoe machines usually stand on top of the mining material and include a backhoe bucket that opens towards the machine. As a result, the backhoe bucket needs to be drawn towards the machine in order to fill the bucket. Face shovel machines, on the other hand, stand in front of the mining material and include a face shovel bucket that opens away from the machine. As a result, the face shovel bucket needs to be pushed away from the machine in order to fill the bucket.

Face shovel machines are typically used to for hard rock mining due to its high digging forces. Face shovel buckets consist of a clam and a back wall that is pivotally connected to the clam. The clam together with the back wall form the bucket in which material is to be filled. During operation of the face shovel machine high forces act onto the face shovel bucket and in particular onto the clam.

The present application is directed at least in part to improve known face shovel buckets.

### SUMMARY OF THE DISCLOSURE

In one aspect, the present disclosure relates to a hydraulic valve block configured to specifically control an operation of a clam actuator of a face shovel bucket of a face shovel machine. The hydraulic valve block comprises a first inlet. The first inlet is configured to be connected to a first hydraulic conduit to supply hydraulic fluid for opening the bucket. The hydraulic valve block further comprises a second inlet. The second inlet is configured to be connected to a second hydraulic conduit to supply hydraulic fluid for closing the bucket. The hydraulic valve block further comprises a first outlet connected to the first inlet via a first line; a second outlet connected to the second inlet via a second line; a two port two position directional control valve, also known as a 2/2 directional control valve, that is interconnected between the first line and the second line; a first pressure relief valve interconnected between the first line and the second line and arranged in series with the two port two position directional control valve; and a second pressure relief valve interconnected between the first line and the second line and arranged in parallel to the first pressure relief valve and the two port two position directional control valve.

In another aspect, the present disclosure relates a hydraulic clam actuator control system of a face shovel bucket of a face shovel machine. The hydraulic clam actuator control system comprises a clam actuator including a rod side chamber and a piston side chamber; a first conduit configured to provide hydraulic fluid to the rod side chamber; a second conduit configured to provide hydraulic fluid to the piston side chamber; and a hydraulic valve block as exemplarily disclosed herein, wherein the first inlet is connected to the first conduit, the second inlet is connected to the second conduit, the first outlet is connected to the rod side chamber, and the second outlet is connected to the piston side chamber.

In another aspect, the present disclosure relates to a face shovel bucket of a face shovel machine. The face shovel bucket comprises a clam actuator. The clam actuator includes a cylinder, a piston disposed within the cylinder and defining a piston side chamber within the cylinder, and a rod connected to the piston, extending at least partially outwardly from the cylinder and defining a rod side chamber within the cylinder. The face shovel bucket further comprises a backwall connected to the cylinder; a clam connected to the rod and pivotally connected to the backwall; and a hydraulic valve block as exemplarily disclose herein, wherein the first outlet is connected to the rod side chamber, and the second outlet is connected to the piston side chamber.

In another aspect, the present disclosure relates to a face shovel bucket attachment of a face shovel machine. The face shovel bucket attachment comprises a face shovel bucket as exemplary disclosed herein; a stick pivotally connected to the face shovel bucket via the back wall of the face shovel bucket; and a boom pivotally connected to the stick and configured to be connected to a superstructure frame of the face shovel machine. The boom includes a first conduit configured to provide hydraulic fluid to the rod side chamber, and a second conduit configured to provide hydraulic fluid to the piston side chamber, wherein the first conduit is connected to the first inlet of the hydraulic valve block, and the second conduit is connected to the second inlet of the hydraulic valve block.

In another aspect, the present disclosure relates to a face shovel machine comprising an undercarriage; an uppercarriage including a superstructure frame rotatably connected to the undercarriage; and a face shovel bucket attachment as exemplary disclosed herein, wherein the face shovel bucket attachment is connected to the superstructure frame.

Other features and aspects of this disclosure will be apparent from the following description and the accompanying drawings.

### BRIEF DESCRIPTION OF THE DRAWINGS

FIG. 1 illustrates an exemplary embodiment of a face shovel machine with a face shovel attachment having a face shovel bucket;

FIG. 2A illustrates a face shovel bucket with a clam and a back wall shown in a closed position of the face shovel bucket;

FIG. 2B illustrates a face shovel bucket with a clam and a back wall shown in an open position of the face shovel bucket;

FIG. 3 illustrates an exemplary embodiment of a hydraulic clam actuator control system for controlling a clam actuator of a face shovel bucket; and

FIG. 4 illustrates an exemplary embodiment of a back wall of an exemplary face shovel bucket with an exemplary hydraulic valve block.

### DETAILED DESCRIPTION

The following is a detailed description of exemplary embodiments of the present disclosure. The exemplary embodiments described herein are intended to teach the principles of the present disclosure, enabling those of ordinary skill in the art to implement and use the present disclosure in many different environments and for many different applications. Therefore, the exemplary embodiments are not intended to be, and should not be considered as a limiting description of the scope of protection. Rather, the scope of protection shall be defined by the appended claims.

The present disclosure is based in part on the realization that when a face shovel bucket is operated in certain operation modes, a clam of the face shovel bucket may be prone to high stresses.

The present disclosure is further based in part on the realization that these operation modes cause a pressure build-up in a hydraulic control system that controls a clam actuator of the face shovel bucket. The clam actuator is a hydraulic actuator that controls a pivot movement of the clam relative to a back wall of the face shovel bucket. The clam actuator includes a cylinder, a piston disposed inside the cylinder and a rod connected to the piston and extending outwardly from the cylinder. The rod is connected to the clam of the face shovel bucket and the cylinder is connected to the back wall of the face shovel bucket. Hence, when the rod extends, the face shovel bucket closes. Likewise, when the rod retracts, the face shovel bucket opens.

The present disclosure is based on the realization that the pressure build-up in the hydraulic control system is due to pressure build-ups in either a rod side chamber or a piston side chamber of the clam actuator during certain operation modes of the face shovel bucket. According to the present disclosure, these pressure build-ups are prevented by providing a dedicated hydraulic clam actuator valve block, i.e. a hydraulic valve block configured to specifically control an operation of the clam actuator of the face shovel bucket. According to the present disclosure, this dedicated hydraulic clam actuator valve block includes a two port two position directional control valve (2/2 directional control valve) interconnected between a first line that is connected to the rod side chamber and a second line that is connected to the piston side chamber, a first pressure relief valve interconnected between the first line and the second line and arranged in series with the 2/2 directional control valve, and a second pressure relief valve interconnected between the first line and the second line and arranged in parallel to the 2/2 directional control valve and the first pressure relief valve.

By providing the above valve arrangement, the first line and the second line are interconnected. Due to this interconnection, pressure that may build up in either the first line or the second line can be relieved to the other line. As a result, a pressure build-up in the rod side chamber or the piston side chamber of the clam actuator is prevented and high stresses in the clam can be reduced.

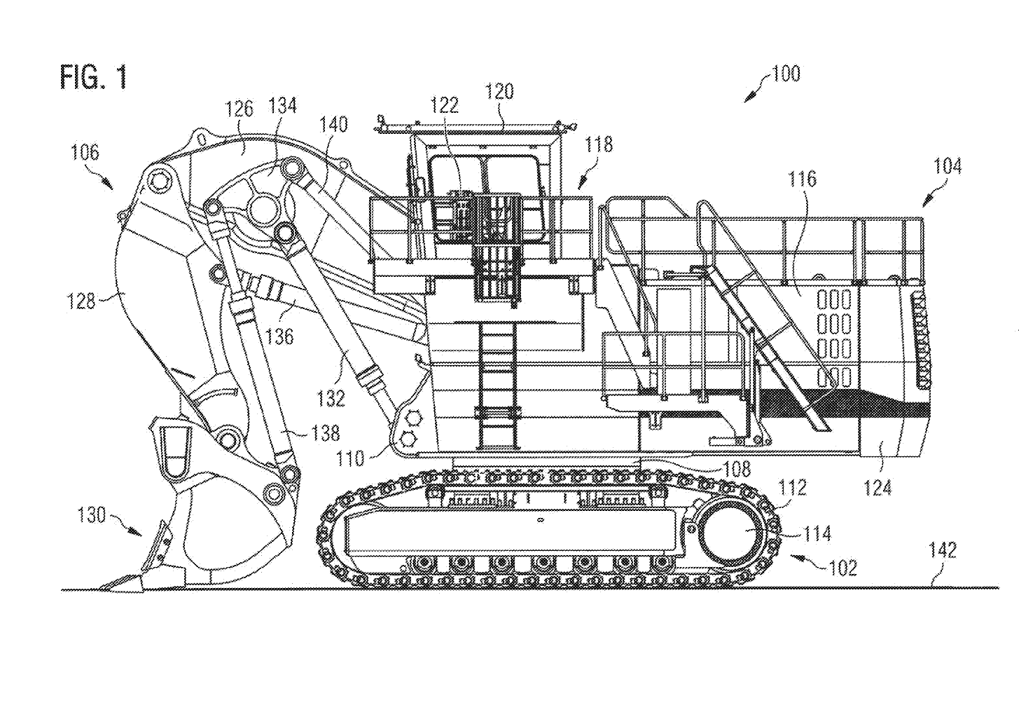

Referring now to the drawings, an exemplary embodiment of a face shovel machine 100 (short: machine 100) is shown in FIG. 1. One skilled in the art would, however, appreciate that machine 100 may be any machine that includes a face shovel bucket. Machine 100 includes an undercarriage 102, an uppercarriage 104, and a face shovel bucket attachment 106. Undercarriage 102 includes a body 108. Uppercarriage 104 includes a superstructure frame 110. Body 108 of undercarriage 102 is pivotally connected to uppercarriage 104 via superstructure frame 110. Undercarriage 102 further includes tracks 112 driven by a travel drive 114. Tracks 112 and travel drive 114 are used to maneuver undercarriage 102 and thus machine 100. Uppercarriage 104 further includes several modules all connected to superstructure frame 110.

Uppercarriage 104 includes an engine module 116 for providing power to machine 100. Engine module 116 may include one or more engines (not shown). Suitable engines may include gasoline powered engines, diesel engines, electrically powered engines or any combination thereof. In one embodiment, engine module 116 may include two diesel engines that generate and transfer power to other components of machine 100 through a power transfer mechanism, for example, a shaft or gearbox (not shown). Engines of engine module 116 may produce mechanical power that may be converted to hydraulic power, for example, by one of more pumps (not shown) powered by the engines.

Uppercarriage 104 further includes an operator module 118 with a cabin 120. Cabin 120 includes controls 122 such as joysticks, levers, buttons, foot pedals, controls and the like. Controls 122 may be operatively connected to a hydraulic system for controlling machine 100.

In some embodiments, cabin 120 may further include interfaces such as a display for conveying information to an operator, and may include a keyboard, a touch screen or any other suitable mechanism for receiving an input from an operator to control or operate machine 100 and components thereof. Alternatively or additionally, an operator may be located outside of cabin 120 and/or some distance away from machine 100 and may control machine 100 and its components remotely.

Uppercarriage 104 may further include other modules such as an oil cooler module (not shown) for preventing overheat of the hydraulic system, or a counterweight module 124 for counterbalancing a payload of machine 100.

Face shovel bucket attachment 106 is attached to uppercarriage 104 via superstructure frame 110. Face shovel bucket attachment 106 is used to dig material and transfer the digged material to a truck or the like. Face shovel bucket attachment 106 includes a boom 126, a stick 128 and a face shovel bucket 130 (short: bucket 130). Boom 126 is mounted to uppercarriage 104 via superstructure frame 110. Stick 128 is mounted to boom 126. And bucket 130 is mounted to stick 128. Boom 126, stick 128 and bucket 130 are pivotally connected to each other via pins. Thus, boom 126, stick 128 and bucket 130 can be pivoted relative to each other and relative to uppercarriage 104.

Pivoting boom 126, stick 128 and bucket 130 is performed by various hydraulic actuators. For example, boom 126 is pivoted by boom actuators 132. Boom actuators 132 control an up and down movement of boom 126 relative to uppercarriage 104. Boom actuators 132 are connected on one side to superstructure frame 110 and on the other side to triangular rockers 134. Triangular rockers 134 are hinge mounted onto boom 126 and used as connection parts for the various other hydraulic actuators of machine 100. For example, stick 128 is pivoted by stick actuators 136. Stick actuators 136 are connected on one side to boom 126 and on the other side to stick 128. Stick actuators 136 control a forward and backward movement of stick 128 relative to uppercarriage 104. Further, bucket 130 is pivoted by bucket actuators 138. Bucket actuators 138 are connected on one side to triangular rockers 134 and on the other side to bucket 130. Bucket actuators 138 control a curl-in or curl-out movement of bucket 130 relative to uppercarriage 104.

Face shovel attachment further includes steering rods 140. Steering rods 140 are attached on one side to superstructure frame 110 and on the other side to triangular rockers 134. Steering rods 140 guide the face shovel bucket attachment 106.

In some embodiments, machine 100 does not include rotating triangular rockers 134 and does not include steering rods 140. In these embodiments, boom actuators 132 and bucket actuators 138 are mounted to pivoting boom 126.

Boom actuators 132, stick actuators 136 and bucket actuators 138 are part of a hydraulic system (not shown). The hydraulic system is used to control boom actuators 132, stick actuators 136 and bucket actuators 138 as well as other components of the hydraulic system such as an actuator for swinging uppercarriage 104 relative to undercarriage 102, or hydraulic motors for driving travel drives 114 to propel machine 100 on a work surface 142.

For controlling the various hydraulic actuators, the hydraulic system may include valves, accumulators, orifices and other suitable components for producing a pressurized flow of hydraulic fluid to, from and through the hydraulic actuators. The hydraulic system may further comprise fluid sources, for example, one or more tanks and/or reservoirs (not shown), and one or more hydraulic pumps, which may include variable displacement pumps, fixed displacement pumps, variable delivery pumps or other suitable pressurizing systems. The hydraulic pumps may be drivably connected to engine module 116, or may be indirectly connected to engine module 116 via a gear mechanism or the like. It is also contemplated that the hydraulic system may include multiple sources of pressurized fluid that are interconnected to provide hydraulic fluid for the hydraulic system. It should be appreciated that, in other embodiments, different numbers of hydraulic motors and/or hydraulic actuators may be provided for the different hydraulic circuits.

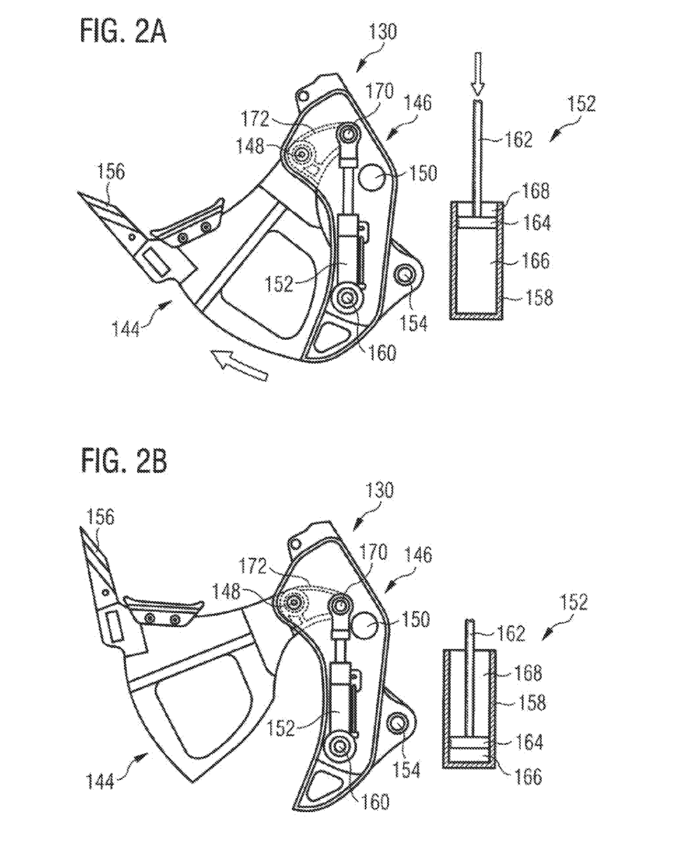

Referring now to FIGS. 2A and 2B, an exemplary embodiment of face shovel bucket 130 according to the present disclosure will be described.

As can be seen, in contrast to a backhoe bucket, a face shovel bucket 130 has two components: a clam 144 and a back wall 146.

Back wall 146 is connected to stick 128 via first connection pins 150 and to bucket actuators 138 via second connection pins 154.

Clam 144 is pivotally connected to back wall 146 via clam connection pins 148. In FIG. 2A face shovel bucket 130 is illustrated with clam 144 and back wall 146 shown in a closed position. In FIG. 2B face shovel bucket 130 is illustrated with clam 144 and back wall 146 shown in an open position. Clam 144 further includes teeth 156 to engage with the mining material for digging the same.

Face shovel bucket 130 further includes clam actuators 152. Clam actuators 152 are disposed on side faces of back wall 146 and are arranged within back wall 146 such that clam actuators 152 are in a safe position and not subjected to debris or other harmful material. Clam actuators 152 control a pivot movement of clam 144 relative to back wall 146, thereby opening and closing face shovel bucket 130.

Each clam actuator 152 includes a cylinder 158. Each clam actuator 152 further includes a piston 164. Piston 164 is movably disposed within cylinder 158. Piston 164 is connected to a rod 162. Rod 162 extends at least partially outwardly from cylinder 158. Piston 164 separates an inner space of cylinder 158 into a first chamber 166 and a second chamber 168. First chamber 166 is disposed on a bottom side of cylinder 158 and formed by cylinder 158 and piston 164. Within the meaning of this disclosure, first chamber 166 therefore constitutes a piston side chamber 166. Second chamber 168 is disposed on a top side of cylinder 158 and formed by cylinder 158, piston 164 and rod 162. Within the meaning of this disclosure, second chamber 168 therefore constitutes a rod side chamber 168.

Each cylinder 158 is connected to back wall 146 via a cylinder connection pin 160. Each rod 162 is connected to clam 144 via a rod connection pin 170. The components of clam 144 in the location where back wall 146 and rod 162 are connected to clam 144 are called levers 172. Clam actuators 152 convert hydraulic power into a linear motion by which rod 162 extends from cylinder 158 or retracts into cylinder 158. Levers 172 convert the linear motion of rods 162 into a rotary clam motion. Hence, when piston side chamber 166 is pressurized by the hydraulic system, rod 162 extends from cylinder 158 and clam 144 rotates towards back wall 146, thereby closing face shovel bucket 130. Exemplarily, in FIG. 2A clam actuator 152 is shown in an extended rod 162 position. This extended position of rod 162 indicates the “closed position” of face shovel bucket 130. When the rod side chamber 168 is pressurized by the hydraulic system, rod 162 retracts into cylinder 158, thereby opening face shovel bucket 130. Exemplarily, in FIG. 2B clam actuator 152 is shown in a retracted rod 162 position. This retracted position of rod 162 indicates the “open position” of face shovel bucket 130. Thus, by “pushing” rod 162 into cylinder 158, clam 144 rotates away from back wall 146, as indicated by the arrows in FIG. 2A.

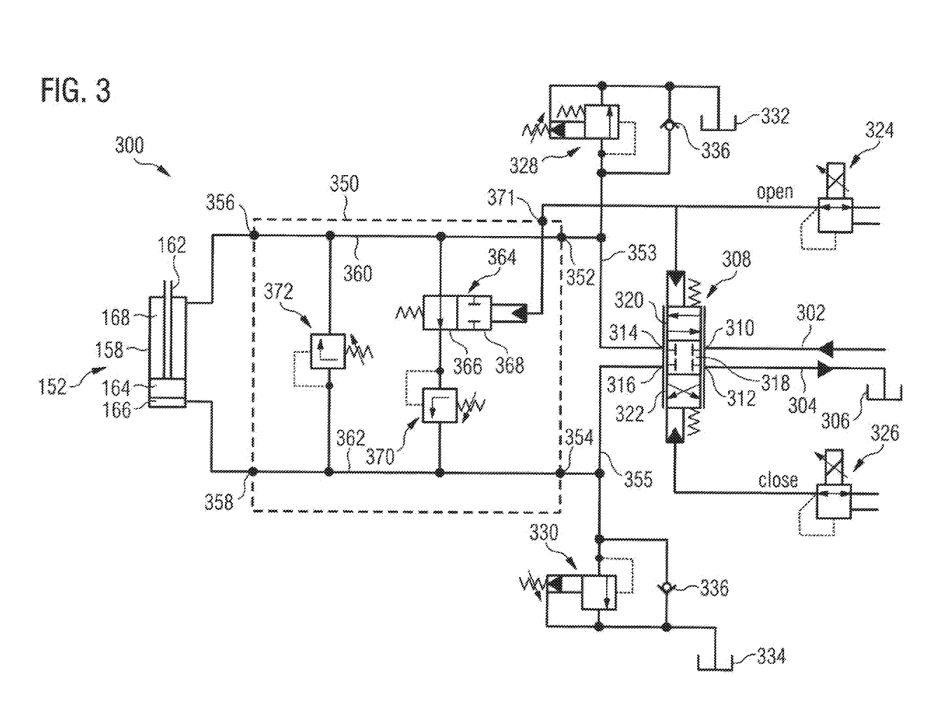

Referring now FIG. 3, an exemplary embodiment of a hydraulic control system 300 controlling clam actuator 152 is shown. Because hydraulic control system 300 controls clam actuator 152, hydraulic control system 300 constitutes a “hydraulic clam actuator control system” 300.

Hydraulic clam actuator control system 300 (short: Hydraulic control system 300) includes a hydraulic pressure supply line 302 and a hydraulic pressure return line 304. Hydraulic pressure supply line 302 supplies pressurized hydraulic fluid (high pressure hydraulic fluid), such as oil, to hydraulic control system 300. Hydraulic pressure return line 304 returns the de-pressurized hydraulic fluid (low pressure hydraulic fluid) to a return tank 306. The hydraulic fluid contained in return tank 306 may be re-pressurized and re-fed into hydraulic pressure supply line 302, thereby closing a hydraulic fluid circuit.

Hydraulic control system 300 further includes a four port three position directional control valve 308 (4/3 directional control valve 308). 4/3 directional control valve 308 is located on boom 126.

4/3 directional control valve 308 includes a first inlet port 310 connected to hydraulic pressure supply line 302 and a second inlet port 312 connected to hydraulic pressure return line 304. 4/3 directional control valve 308 further includes a first outlet port 314 and a second outlet port 316.

4/3 directional control valve 308 further includes a first position 318 in which a connection between first inlet port 310 and first outlet port 314 and a connection between second inlet port 312 and second outlet port 316 is blocked. Hence, when 4/3 directional control valve 308 is positioned in first position 318, no fluid is transferred between first and second inlet ports 310, 312 and first and second outlet ports 314, 316.

4/3 directional control valve 308 further includes a second position 320 in which first inlet port 310 is connected to first outlet port 314 and in which second inlet port 312 is connected to second outlet port 316. Hence, when 4/3 directional control valve 308 is positioned in second position 320, first outlet port 314 supplies pressurized hydraulic fluid to the remaining hydraulic system and second outlet port 316 returns de-pressurized hydraulic fluid to return tank 306.

4/3 directional control valve 308 further includes a third position 322 in which first inlet port 310 is connected to second outlet port 316 and in which second inlet port 312 is connected to first outlet port 314. Hence, when 4/3 directional control valve 308 is positioned in third position 322, second outlet port 316 supplies pressurized hydraulic fluid to the remaining hydraulic system and first outlet port 314 returns de-pressurized hydraulic fluid to return tank 306.

First outlet port 314 is connected to rod side chamber 168 of clam actuator 152. Second outlet port 316 is connected piston side chamber 166 of clam actuator 152.

Hence, when 4/3 directional control valve 308 is positioned in second position 320, i.e. the position in which first outlet port 314 supplies pressurized hydraulic fluid to the remaining hydraulic system, rod side chamber 168 gets pressurized. As a result, rod 162 retracts into cylinder 158 and clam 144 pivots away from back wall 146, thereby opening face shovel bucket 130 (see FIG. 2B).

Likewise, when 4/3 directional control valve 308 is positioned in third position 322, i.e. the position in which second outlet port 316 supplies pressurized hydraulic fluid to the remaining hydraulic system, piston side chamber 166 gets pressurized. As a result, rod 162 extends and clam 144 pivots towards back wall 146, thereby closing face shovel bucket 130 (see FIG. 2A).

Switching between first, second and third position 318, 320, 322 is performed by a first proportional reducing valve (first proportional valve) 324 and a second proportional reducing valve (second proportional valve) 326. Both first and second proportional reducing valves 324, 326 are electrically controlled. When first and second proportional reducing valves 324, 326 are energized by amperage, pilot pressure to 4/3 directional control valve 308 is provided and, as a result, the position of 4/3 directional control valve changes.

Control of 4/3 directional control valve 308 can be electrically, for example by a solenoid, hydraulically or mechanically.

First and second proportional reducing valves 324, 326 are, for example, actuated by a first and a second electrically controlled control (not shown) disposed in cabin 120 of machine 100. First and second controls are operatively connected to first and second proportional reducing valves 324, 326, respectively. Hence, when the operator of machine 100 presses a first control operatively connected to first proportional reducing valves 324, 4/3 directional control valve 308 shifts into second position 320. As a result, face shovel bucket 130 opens. When, the operator of machine 100 presses a second control operatively connected to second proportional reducing valve 326, 4/3 directional control valve 308 shifts into third position 322. As a result, face shovel bucket 130 closes. First and second controls may be integrally formed in on control.

4/3 directional control valve 308 is further biased to first position 318 (neutral position 318), for example, by springs. Thus, neutral position 318 is the default position of 4/3 directional control valve 308. Hence, when the operator does not press any control, i.e. when the operator does neither actuate first proportional reducing valve 324 nor second proportional reducing valve 326, 4/3 directional control valve 308 adopts neutral position 318. In neutral position 318 hydraulic fluid is “locked” between rod side chamber 168 and first outlet port 314, as well as between piston side chamber 166 and second outlet port 316.

When 4/3 directional control valve 308 is in neutral position 318, any movement of rod 162 within cylinder 158, for example due to external forces acting upon clam 144, causes a pressure difference between rod side chamber 168 and piston side chamber 166. Hence, when 4/3 directional control valve 308 is in neutral position 318 and clam 144 is forced by external forces to pivot away from back wall 146, pressure in piston side chamber 166 will increase. Likewise, when 4/3 directional control valve 308 is in neutral position 318 and clam 144 is forced by external forces to pivot towards back wall 146, pressure in rod side chamber 168 will increase.

Hydraulic control system 300 further includes a first secondary relief valve 328 and a second secondary relief valve 330. First secondary pressure relief valve 328 is disposed between rod side chamber 168 and first outlet port 314. Second secondary pressure relief valve 330 disposed between piston side chamber 166 and second outlet port 316. First and second secondary pressure relief valves 328, 330 are located on boom 126.

First secondary pressure relief valve 328 connects rod side chamber 168 to a tank 332. Second secondary pressure relief valve 330 connects piston side chamber 166 to a tank 334. Tanks 332, 334 may be different tanks or may be the same tank as return tank 306. First and second secondary pressure relief valves 328, 330 are configured as pressure limiting valves. Thus, if a pressure in rod side chamber 168 exceeds a predetermined set pressure, first secondary pressure relief valve 328 opens and relieves pressure to tank 332. Likewise, if a pressure in piston side chamber 166 exceeds a predetermined set pressure, second secondary pressure relief valve 330 opens and relieves pressure to tank 334. The set pressure of first and second secondary pressure relief valves 328, 330 may be in a range between 200 bar and 400 bar. First secondary pressure relief valve 328 and second secondary pressure relief valve 330 further include make-up valves 336. Make-up valves 336 allow hydraulic fluid to be drawn from tanks 332 and 334 to prevent voiding in road side chamber 168 or piston side chamber 166, respectively.

As can be further seen in FIG. 3, hydraulic control system 300 includes a hydraulic valve block 350. Hydraulic valve block 350 is disposed between clam actuator 152 and 4/3 directional control valve 308. Hydraulic valve block 350 is a dedicated hydraulic valve block specifically configured to control operation of clam actuator 152. Hydraulic valve block 350 therefore constitutes a “hydraulic clam actuator valve block” 350.

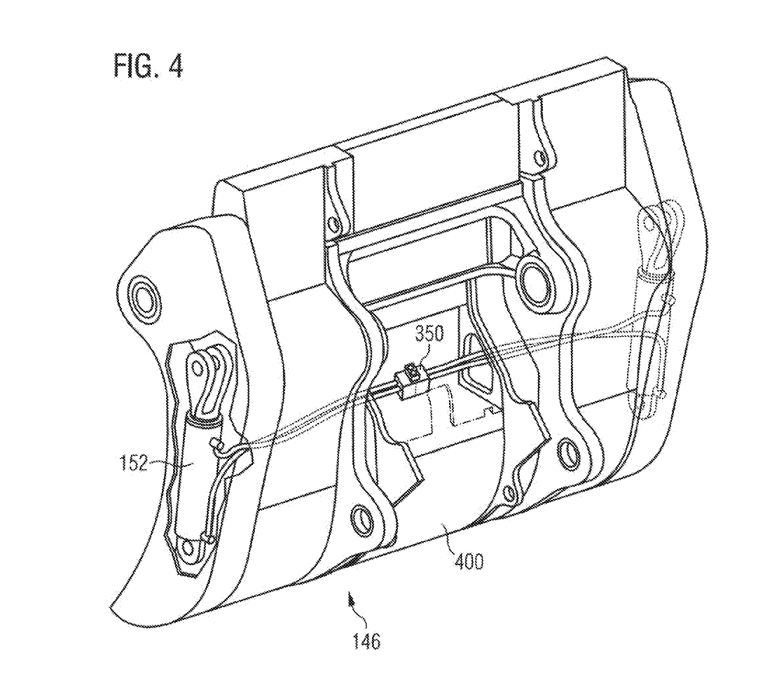

Referring to FIG. 4, it can be seen that hydraulic valve block 350 is positioned on a rear side 400 of back wall 146 of face shovel bucket 130. Hence, compared to first and second secondary pressure relief valves 328, 330 which are located on boom 126, hydraulic valve block 350 is disposed closer to clam actuator 152. As a result, hydraulic valve block 350 can react faster to pressure build-ups in clam actuator 152. Moreover, hydraulic valve block 350 can easily be accessed, for example for servicing, replacement in the field and maintenance. Furthermore, as hydraulic valve block 350 is position on a rear side 400 of back wall 146, hydraulic valve block 350 is positioned in a safe area not prone to debris or the like.

Referring back to FIG. 3, hydraulic valve block 350 includes a first inlet 352. First inlet 352 is connected to first outlet port 314 of 4/3 directional control valve 308 via a first conduit 353. Hydraulic valve block 350 further includes a second inlet 354. Second inlet 354 is connected to second outlet port 316 of 4/3 directional control valve 308 via a second conduit 355. As first conduit 353 is connected to first outlet port 314, first conduit 353 is configured to provide hydraulic fluid to rod side chamber 168. As second conduit 355 is connected to second outlet port 316, second conduit 355 is configured to provide hydraulic fluid to piston side chamber 166. First conduit 353 and second conduit 355 are disposed on boom 126.

Hydraulic valve block 350 further includes a first outlet 356 connected to rod side chamber 168, and a second outlet 358 connected to piston side chamber 166. First inlet 352 and first outlet 356 are connected via a first line 360. Second inlet 354 and second outlet 358 are connected via a second line 362. Hence, first line 360 is connected to rod side chamber 168 and second line 362 is connected to piston side chamber 166.

Hydraulic valve block 350 further includes a two port two position directional control valve 364 (2/2 directional control valve 364). 2/2 directional control valve 364 is interconnected between first line 360 and second line 362. 2/2 directional control valve 364 is configured as a cross-over valve between first line 360 and second line 362. For this, 2/2 directional control valve 364 includes a first position 366 in which hydraulic fluid is allowed to flow only from first line 360 to second line 362. 2/2 directional control valve 364 further includes a second position 368 in which hydraulic fluid is prevented from flowing between first and second lines 360, 362.

Hydraulic valve block 350 further includes a first pressure relief valve 370. First pressure relief valve 370 is configured as a cross-over pressure relief valve. First pressure relief valve 370 is interconnected between first line 360 and second line 362 and arranged in series with 2/2 directional control valve 364. Thus, when 2/2 directional control valve 364 is in first position 366, hydraulic fluid flows from first line 360 to second line 362 by first passing 2/2 directional control valve 364 and then passing first pressure relief valve 370. In some embodiments, first pressure relief valve 370 may be arranged such that hydraulic fluid first passes first pressure relief valve 370 and then passes 2/2 directional control valve 364.

2/2 directional control valve 364 is biased to first position 366, for example, by a spring. 2/2 directional control 364 valve is further pilot controlled such that upon supplying a pilot pressure, 2/2 directional control 364 valve switches from first position 366 to second position 368. As can be seen in FIG. 3, 2/2 directional control valve 364 is connected to first proportional reducing valve 324. Hydraulic valve block 350 therefore includes a third inlet 371. Third inlet 371 is configured to connect 2/2 directional control valve 364 to first proportional reducing valve 324 for switching 2/2 directional control valve between first position 366 and second position 368. The connection between first proportional reducing valve 324 and hydraulic valve block 350, more specifically the connection between first proportional reducing valve 324 and third inlet 371, can be electrically, for example by a solenoid, hydraulically or mechanically. Preferably, the connection between first proportional reducing valve 324 and hydraulic valve block 350 is a hydraulic connection, because a hydraulic connection is better suited for the harsh environment in which face shovel machines work.

It should be recalled, that first proportional reducing valve 324 provides pilot pressure to 4/3 directional control valve 308 in order to switch 4/3 directional control valve 308 into second position 320, thereby opening face shovel bucket 130. Because 2/2 directional control valve 364 is also connected to first proportional reducing valve 324, whenever the operator of machine 100 wants to open face shovel bucket 130 and actuates first proportional reducing valve 324 (for example by pressing the first control), 2/2 directional control valve 364 is switched to second position 368. As a result, first line 360 and second line 362 are disconnected. Hence, pressurized hydraulic fluid can be transferred from first conduit 353, to first line 360 and then to rod side chamber 168 to open face shovel bucket 130 with full pressure.

As can be seen, first pressure relief valve 370 is configured to allow fluid to flow only from first line 360 to second line 362. Moreover, first pressure relief valve 370 includes a first set pressure. Thus, as long as the pressure in first line 360, i.e. in rod side chamber 168, does not exceed the first set pressure, fluid is not allowed to flow from first line 360 to second line 362 even when 2/2 directional control valve 364 is in its first position 366.

Hydraulic valve block 350 further includes a second pressure relief valve 372. Second pressure relief valve 372 is configured as cross-over pressure relief valve. Second pressure relief valve 372 is interconnected between first line 360 and second line 362. Moreover, second pressure relief valve 372 is arranged in parallel to first pressure relief valve 370 and 2/2 directional control valve 364. As can be seen, second pressure relief valve 372 is configured to allow fluid to flow only from second line 362 to first line 360. Moreover, second pressure relief valve 372 includes a second set pressure. Thus, as long as the pressure in second line 362, i.e. in piston side chamber 166, does not exceed the second set pressure, fluid is not allowed to flow from second line 362 to first line 360.

As the first pressure relief valve 370 secures a maximal set pressure in rod side chamber 168, i.e. the chamber that needs to be pressurized for opening face shovel bucket 130, the first set pressure may be in a range of pressure that corresponds to a force sufficiently large enough to keep face shovel bucket 130 open and prevent face shovel bucket 130 from automatic closure due to its weight. Likewise, as the second pressure relief valve 372 secures a maximal set pressure in piston side chamber 166, i.e. the chamber that needs to be pressurized for closing face shovel bucket 130, the second set pressure may be in a range of pressure that corresponds to a minimal force necessary to close face shovel bucket 130. For example, the first set pressure may be in a range between 70 bar and 200 bar, preferably between 100 bar and 200 bar, or larger, 130. For example, the second set pressure may be in a range between 70 bar and 150 bar, preferably between 70 bar and 120 bar. First and second set pressure depend on the type and weight of face shovel bucket 130 and may be calculated in advance. In some embodiments, the first set pressure and the second set pressure may be the same pressure.

It is to be understood that the value to which the modifier “about” refers is itself also specifically, and preferably, disclosed. The recitation of numerical ranges by endpoints includes all numbers and fractions subsumed within the respective ranges, as well as the recited endpoints.

### INDUSTRIAL APPLICABILITY

Exemplary machines suited for hydraulic valve block 350 are face shovel machines with a clam actuator such as clam actuator 152. Such face shovel machines are, for example, face shovel machines of the series 6015, 6018, 6020, 6030, 6040, 6050, 6060 and 6090 manufactured by Caterpillar Global Mining HMBS GmbH. One skilled in the art would, however, appreciate that hydraulic valve block 350 may be also suited for other machines with a clam actuator.

In the following, various operations of machine 100 are exemplarily explained in connection with hydraulic valve block 350.

For example, when an operator of machine 100 wants to close face shovel bucket 130, he presses the second control which actuates second proportional reducing valve 326. In this situation, 4/3 directional control valve 308 switches from its biased position 318 to third position 322 in which piston side chamber 166 is provided with pressurized hydraulic fluid. Because the set pressure of second pressure relief valve 372 is configured such that it is higher than a pressure that is needed to close face shovel bucket 130, pressure in piston side chamber 166 builds up and face shovel bucket 130 can be closed.

If, however, the operator unintentionally continuous to close face shovel bucket 130, i.e. continuously presses the second control to actuate second proportional reducing valve 326 although clam 144 already contacts back wall 146, rod 162 continuous to be fully extended. Because rod 162 cannot extend further from cylinder 158, clam actuator 152 is in a static position. As in this static position of clam actuator 152 pressurized hydraulic fluid is, however, continuously pumped into piston side chamber 166 (due to the operator continuously pressing the second control), a pressure build-up in piston side chamber 166 occurs. But, because second pressure relief valve 372 is configured such that hydraulic fluid is allowed to flow from piston side chamber 166 to rod side chamber 168 for pressures larger than the set pressure of second pressure relief valve 372, the pressure in piston side chamber 166 is relieved into rod side chamber 168. As a result, an unnecessary high pressure in piston side chamber 166 is prevented.

Next, if the operator wants to open face shovel bucket 130, he presses the first control. The first control operates first proportional reducing valve 324. Upon actuating first proportional reducing valve 324, pilot pressure is provided from first proportional reducing valve 324 to 4/3 directional control valve 308. 4/3 directional control valve 308 then shifts from its biased position 318 to second position 320 in which pressurized hydraulic fluid is supplied to rod side chamber 168. The pressurized hydraulic fluid would, however, flow to piston side chamber 166 as 2/2 directional control valve 364 is in its first position (biased position) 366. But, because first proportional reducing valve 324 also provides pilot pressure to 2/2 directional control valve 364, 2/2 directional control valve 364 switches to second position 368 in which first line 360 and second line 362 are disconnected. As a result, pressure can be transferred from first line 360 to rod side chamber 168 and face shovel bucket 130 can be opened.

Next, if the operator wants to leave face shovel bucket 130 open and move it around, the operator will no longer actuate the first or second controls and, hence, no longer actuate first proportional reducing valve 324 or second proportional reducing valve 326. As a result, 2/2 directional control valve 364 switches back to its biased position, i.e. first position 366, in which first line 360 and second line 362 are connected. In this situation, hydraulic fluid would flow from pressurized rod side chamber 168 to piston side chamber 166. As a result, face shovel bucket 130 would involuntarily close. But, because first pressure relief valve 370 is arranged in series with 2/2 directional control valve 364, hydraulic fluid in rod side chamber 168 can only flow up to first pressure relief valve 370. And because first pressure relief valve 370 includes a set pressure that corresponds to a pressure that is necessary to compensate the mass force of clam 144, clam 144 will not pivot towards back wall 146. Hence, face shovel bucket 130 remains open.

If, on the other hand, an operator wants to intentionally open face shovel bucket 130, he will press the first control. As a result, the first control actuates first proportional reducing valve 324. This causes 2/2 directional control valve 364 to switch to second position 368 in which first line 360 and second line 362 are disconnected. As a result, first line 360 is pressurized, the pressure is transferred to rod side chamber 168, thereby opening face shovel bucket 130.

In the following, various operations of face shovel bucket 130 are exemplarily described that represent intentional misuse of face shovel bucket 130.

As a first example, an operator of machine 100 wants to dig up material with a not fully closed face shovel bucket 130. In this situation clam 144 hits the material in front of it. As a result, clam 144 is forced to pivot towards back wall 146. As in this situation the operator does not actuate first and second proportional reducing valve 324, 326, 4/3 directional control valve 308 is in its biased position 318. As a consequence, hydraulic fluid is “locked” between rod side chamber 168 and first outlet port 314, as well as between piston side chamber 166 and second outlet port 316. If in this situation external forces (for example by digging with a not fully closed bucket) act upon clam 144, these external forces are counteracted by the hydraulic system. As a result, a pressure build-up occurs in rod side chamber 168, because the external forces try to pivot clam 144 towards back wall 146, thereby forcing rod 162 to extending outwardly of cylinder 158. According to the present disclosure, this pressure build-up is, however, limited to the first set pressure, because 2/2 directional control valve 364 is in this situation in its biased position 366. As a result, first line 360 is connected to second line 362. Thus, hydraulic fluid may flow from rod side chamber 168 via first line 360 to first pressure relief valve 370. If the pressure in rod side chamber 168, however, exceeds the first set pressure of first pressure relief valve 370, hydraulic fluid can flow further towards second line 362 and then to piston side chamber 166. Hence, a pressure build-up in rod side chamber 168 is prevented by transferring pressure from rod side chamber 168 to piston side chamber 166. As a result, face shovel bucket 130 will close and the operator can dig material without causing an unnecessary high pressure in rod side chamber 168.

As another example, if an operator wants to clean the work surface 142 by drawing a half-open face shovel bucket 130 towards machine 100, the external forces will try to open face shovel bucket 130 further. As a result, a pressure build-up in piston side chamber 166 occurs, because the external forces try to pivot clam 144 away from back wall 146, thereby forcing rod 162 to retract into cylinder 158. According to the present disclosure, this pressure build-up is, however, prevented because second pressure relief valve 372 is configured to allow a flow of fluid from second line 362 to first line 360 at the second set pressure. Thus, an unnecessary high pressure in piston side chamber 166 is prevented. Moreover, as hydraulic fluid flows from piston side chamber 166 to rod side chamber 168, the face shovel bucket 130 opens completely, thereby indicating an operator the misuse of face shovel bucket 130.

Thus, hydraulic valve block 350 allows an operator to routinely open and close face shovel bucket 130 without creating unnecessary high pressure build-ups. At the same time, hydraulic valve block 350 also provides a security means for limiting pressure build-ups during intentional or unintentional misuse of face shovel bucket 130 to the first and second set pressures.

Although the preferred embodiments of this invention have been described herein, improvements and modifications may be incorporated without departing from the scope of the following claims.

1. A hydraulic valve block configured to specifically control an operation of a clam actuator of a face shovel bucket of a face shovel machine, the hydraulic valve block comprising:
a first inlet;
a second inlet;
a first outlet connected to the first inlet via a first line;
a second outlet connected to the second inlet via a second line;
a two port two position directional control valve interconnected between the first line and the second line;
a first pressure relief valve interconnected between the first line and the second line and arranged in series with the two port two position directional control valve; and
a second pressure relief valve interconnected between the first line and the second line and arranged in parallel to the first pressure relief valve and the two port two position directional control valve.

2. The hydraulic valve block according to claim 1, wherein the two port two position directional control valve is configured to adopt a first position in which hydraulic fluid is allowed to flow from the first line to the second line.

3. The hydraulic valve block according to claim 2, wherein the first pressure relief valve is configured to allow hydraulic fluid to flow only from the first line to the second line.

4. The hydraulic valve block according to claim 3, wherein the second pressure relief valve is configured to allow hydraulic fluid to flow only from the second line to the first line.

5. The hydraulic valve block according to claim 1, wherein the first pressure relief valve is configured to include a first set pressure and the second pressure relief valve is configured to include a second set pressure.

6. The hydraulic valve block according to claim 5, wherein the first set pressure is equal to or larger than the second set pressure.

7. The hydraulic valve block according to claim 5, wherein the first set pressure is in a range between about 70 bar and about 200 bar, preferably between about 100 bar and 200 bar, and wherein the second set pressure is in a range between about 70 bar and about 150 bar, preferably between about 70 bar and about 120 bar.

8. The hydraulic valve block according to claim 1, wherein the two port two position directional control valve is configured to adopt a second position in which hydraulic fluid is prevented from flowing between the first line and the second line.

9. A hydraulic clam actuator control system of a face shovel bucket of a face shovel machine, the hydraulic clam actuator control system comprising:
a clam actuator including a rod side chamber and a piston side chamber;
a first conduit configured to provide hydraulic fluid to the rod side chamber;
a second conduit configured to provide hydraulic fluid to the piston side chamber; and
a hydraulic valve block according to any one of the preceding claims, wherein
the first inlet is connected to the first conduit;
the second inlet is connected to the second conduit;
the first outlet is connected to the rod side chamber; and
the second outlet is connected to the piston side chamber.

10. The hydraulic clam actuator control system (300) of claim further comprising:
a first proportional reducing valve disposed in the first conduit and connected to the two port two position directional control valve via a third inlet of the hydraulic valve block for controlling an operation of the two port two position directional control valve.

11. The hydraulic clam actuator control system of claim 10, wherein
the hydraulic clam actuator control system is configured to operate in a first mode, wherein the first proportional reducing valve is de-actuated such that the two port two position directional control valve adopts a first position in which hydraulic fluid is allowed to flow between the first line and the second line, and wherein
the hydraulic clam actuator control system is configured to operate in a second mode, wherein the first proportional reducing valve is actuated to switch the two port two position directional control valve from the first position into the second position in which hydraulic fluid is prevented from flowing between the first line and the second line.

12. A face shovel bucket of a face shovel machine, the face shovel bucket comprising:
a clam actuator including
a cylinder,
a piston disposed within the cylinder and defining a piston side chamber within the cylinder, and
a rod connected to the piston, extending at least partially outwardly from the cylinder and defining a rod side chamber within the cylinder;
a back wall connected to the cylinder;
a clam connected to the rod and pivotally connected to the back wall (146); and
a hydraulic valve block according to claim 1, wherein
the first outlet is connected to the rod side chamber, and
the second outlet is connected to the piston side chamber.

13. The face shovel bucket according to claim 12, wherein the hydraulic valve block is disposed on an a rear side of the back wall.

14. A face shovel bucket attachment of a face shovel machine, the face shovel bucket attachment comprising:
a face shovel bucket according to claim 12;
a stick pivotally connected to the face shovel bucket via the back wall of the face shovel bucket; and
a boom pivotally connected to the stick and configured to be connected to a superstructure frame of the face shovel machine, the boom including
a first conduit configured to provide hydraulic fluid to the rod side chamber, and
a second conduit configured to provide hydraulic fluid to the piston side chamber, wherein
the first conduit is connected to the first inlet of the hydraulic valve block, and
the second conduit is connected to the second inlet of the hydraulic valve block.

15. A face shovel machine comprising:
an undercarriage;
an uppercarriage including a superstructure frame rotatably connected to the undercarriage; and
a face shovel bucket attachment according to claim 14, wherein the face shovel bucket attachment is connected to the superstructure frame.
